(19) United States
(12) Patent Application Publication
(10) Pub. No.: US 2024/0014421 A1
(43) Pub. Date: Jan. 11, 2024

(54) FUEL CELL SYSTEM AND PURGING CONTROL METHOD THEREOF

(71) Applicant: HYUNDAI MOBIS CO., LTD., Seoul (KR)

(72) Inventor: Yong Hee LEE, Yongin-si (KR)

(73) Assignee: HYUNDAI MOBIS CO., LTD., Seoul (KR)

(21) Appl. No.: 18/218,200

(22) Filed: Jul. 5, 2023

(30) Foreign Application Priority Data
Jul. 5, 2022 (KR) 10-2022-0082379

(51) Int. Cl. H01M 8/04223; H01M 8/04858; H01M 8/2465; H01M 8/04746

(52) U.S. Cl. CPC H01M 8/04231; H01M 8/0491; H01M 8/2465; H01M 8/04776

(57) ABSTRACT

Disclosed a fuel cell system including an air pump that injects air into a fuel cell stack, a purge valve that performs hydrogen purging based on an opening degree, and a controller that calculates a cumulative current of the fuel cell, and performs at least one of a first operation of controlling the number of rotations of the air pump based on the cumulative current, a second operation of controlling the opening degree of the purge valve, or a combination of the first operation and the second operation.

### CROSS-REFERENCE TO RELATED APPLICATION

This application claims the benefit of priority to Korean Patent Application No. 10-2022-0082379, filed in the Korean Intellectual Property Office on Jul. 5, 2022, the entire contents of which are incorporated herein by reference.

### TECHNICAL FIELD

Embodiments disclosed herein relate to a fuel cell system and a purging control method thereof.

### BACKGROUND

A fuel cell system may generate electrical energy using a fuel cell stack. For example, when hydrogen is used as a fuel for a fuel cell stack, continuous research and development on fuel cell systems is being conducted because the hydrogen can be an alternative solution to global environmental problems. The fuel cell system may include a fuel cell stack that generates electrical energy, a fuel supply device that supplies fuel (hydrogen) to the fuel cell stack, an air supply device that supplies oxygen in the air, which is an oxidant required for electrochemical reactions, to the fuel cell stack, and a thermal management system (TMS) that removes reaction heat from the fuel cell stack to the outside of the system, controls the operating temperature of the fuel cell stack, and performs a water management function.

The fuel cell system may generate electricity by reacting hydrogen, which is a fuel, with oxygen in the air to react in the fuel cell stack, and discharge heat and water as reaction by-products. In such a fuel cell system, as crossover occurs due to a difference in gas concentration between the anode and the air electrode in the fuel cell stack, hydrogen gas from the cathode diffuses to the cathode, reducing the hydrogen concentration of the anode, thereby reducing the hydrogen concentration of the fuel cell stack. The cell voltage of the fuel cell stack decreases. To this end, the fuel cell system maintains the hydrogen concentration of the hydrogen electrode within a certain range by discharging residual hydrogen through hydrogen purging.

Due to the crossover phenomenon of nitrogen generated in the fuel cell stack, the fuel cell system generally supplies a larger amount of hydrogen than the amount of hydrogen required for the reaction, and includes an ejector for reusing the hydrogen. However, there is no separate method for treating nitrogen contained in hydrogen entering the ejector, there is a problem in that the concentration of nitrogen gradually increases and affects the performance of the fuel cell unless the hydrogen is periodically purged.

In order to solve this problem, hydrogen purging is performed periodically based on a current integration method, but there is a problem that frequent hydrogen purging causes excessive hydrogen consumption and lowers system efficiency.

### SUMMARY

The present disclosure has been made to solve the above-mentioned problems occurring in the prior art while advantages achieved by the prior art are maintained intact.

An aspect of the present disclosure provides a fuel cell system capable of reduce nitrogen crossover by adjusting an air partial pressure by controlling the number of rotations of an air pump.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a fuel cell system includes an air pump that injects air into a fuel cell stack, a purge valve that performs hydrogen purging based on an opening degree, and a controller that calculates a cumulative current of the fuel cell, and performs at least one of a first operation of controlling the number of rotations of the air pump based on the cumulative current, a second operation of controlling the opening degree of the purge valve, or a combination of the first operation and the second operation.

According to an embodiment, the controller may reduce the number of rotations of the air pump when the cumulative current is greater than or equal to a first value.

According to an embodiment, the controller may perform control to perform the hydrogen purging by opening the purge valve when the cumulative current is greater than or equal to a reference value.

According to an embodiment, the reference value may be set greater than the first value.

According to an embodiment, the controller may adjust the reference value based on an output efficiency of the fuel cell.

According to an embodiment, the controller may determine reference efficiency based on the output efficiency.

According to an embodiment, the controller may adjust the reference value from a second value to a third value when the output efficiency is greater than or equal to the reference efficiency, and the third value may be set greater than the second value.

According to an embodiment, the controller may adjust the reference value from the third value to the second value when the output efficiency is less than the reference efficiency after being equal to or greater than the reference efficiency.

According to an embodiment, the controller may adjust the first value based on the reference value.

According to an aspect of the present disclosure, a purging control method for a fuel cell includes calculating a cumulative current of the fuel cell and performing at least one of a first operation of controlling the number of rotations of an air pump based on the cumulative current, a second operation of controlling an opening degree of a purge valve, or a combination of the first operation and the second operation.

According to an embodiment, the purging control method may include comparing the cumulative current with a first value, and reducing the number of rotations of the air pump when the cumulative current is equal to or greater than the first value.

According to an embodiment, the purging control method may include comparing the cumulative current with a second value, and opening the purge valve when the cumulative current is greater than or equal to the second value.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram showing a fuel cell system according to an embodiment disclosed herein;

FIG. 2 is a block diagram of a fuel cell system according to an embodiment disclosed herein;

FIG. 3A is a diagram illustrating a process of determining reference efficiency of a fuel cell system according to an embodiment disclosed herein;

FIG. 3B is a diagram illustrating a process of controlling purging timing of a purge valve based on the output efficiency of a fuel cell system according to an embodiment disclosed herein;

FIG. 4 is a flowchart for describing a purging control method for a fuel cell according to an embodiment disclosed herein;

FIG. 5 is a diagram showing a method of adjusting the number of rotations of an air pump according to an embodiment disclosed herein; and

FIG. 6 is a diagram showing a method of controlling a purge valve according to an embodiment disclosed herein.

### DETAILED DESCRIPTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure.

In the present disclosure, the singular form of a noun corresponding to an item may include one item or a plurality of items, unless the context clearly dictates otherwise. As used herein, expressions such as “A or B”, “at least one of A and B”, “at least one of A or B”, “A, B or C”, “at least one of A, B and C” and “A, or “at least one of A, B or C” may include any one of items listed together in the corresponding one of the expressions, or all possible combinations thereof. The terms such as “1st”, “2nd”, “first”, “second”, and the like used herein may simply be used to distinguish a given component from other given components, and may be used to limit the given component in another aspect (e.g., importance or order). When a certain (e.g., first) component is mentioned as being “coupled” or “connected” to another (e.g., second) component, with or without the terms “operatively” or “communicatively”, it means that the certain component is able to be connected to the other component directly (e.g., by wire), wirelessly, or through a third component.

Each component (e.g., module or program) of the components described herein may include singular or plural entities. According to various embodiments, one or more components or operations among corresponding components may be omitted, or one or more other components or operations may be added. Alternatively or additionally, a plurality of components (e.g., modules or programs) may be integrated into a single component. In this case, the integrated component may perform one or more functions of the plurality of components in an identical or similar manner to those performed by a corresponding component of the plurality of components prior to the integration. According to various embodiments, operations performed by modules, programs, or other components are executed sequentially, in parallel, iteratively, or heuristically, or one or more of the operations are executed in a different order or omitted or one or more other operations may be added.

As used herein, the term “module” or “ . . . unit” may include units implemented in hardware, software, or firmware, and may be used interchangeably with, for example, logic, logic blocks, parts, or circuits. The “module” may be a minimum unit of an integrated part or a part thereof or may be a minimum unit for performing one or more functions or a part thereof. For example, according to an embodiment, the module may be implemented in the form of an application-specific integrated circuit (ASIC).

Various embodiments of the present disclosure may be implemented as software (e.g., a program or application) including one or more instructions stored in a storage medium (e.g., memory) readable by a machine. For example, the processor of a device may invoke at least one instruction among one or more stored commands from a storage medium and execute the instruction. This enables the device to be operated to perform at least one function according to the at least one instruction invoked. The one or more instructions may include codes generated by a compiler or codes executable by an interpreter. The device-readable storage medium may be provided in the form of a non-transitory storage medium. Here, ‘non-temporary’ only means that the storage medium is a tangible device and does not contain a signal (e.g., electromagnetic wave), and this term does not distinguish between a case where data is semi-permanently stored in a storage medium and a case where data is temporarily stored.

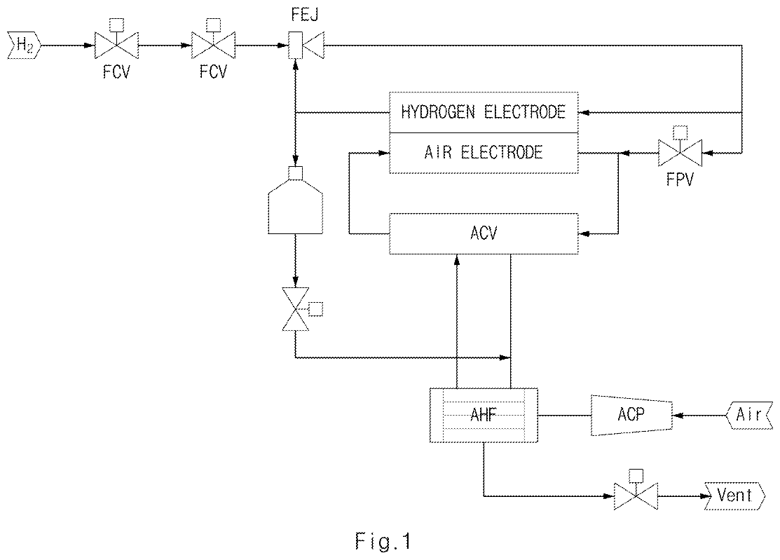

FIG. 1 is a diagram showing a fuel cell system according to an embodiment disclosed herein.

Referring to FIG. 1, a fuel cell system may include a fuel cell stack 10, and may further include a hydrogen supply line 11 connected to the hydrogen electrode of the fuel cell stack and through which hydrogen supplied to the fuel cell stack 10 is moved, an air supply line 21 connected to the air electrode of the fuel cell stack 10 and through which air supplied to the fuel cell stack 10 is moved, discharge lines 31, 33, and 35 for discharging moisture (water) or unreacted gas, which are reaction by-product, to the outside and a purge line 41.

The fuel cell stack 10 (or may be referred to as a ‘fuel cell’) may be formed to have a structure capable of generating electricity through an oxidation-reduction reaction between a fuel (e.g., hydrogen) and an oxidant (e.g., air).

For example, the fuel cell stack 10 may include a membrane electrode assembly (MEA) with catalyst electrode layers in which electrochemical reactions occur on both sides of an electrolyte membrane through which protons move, a gas diffusion layer (GDL) that evenly distributes reactive gases and transmits generated electrical energy, a gasket and fastening mechanism that maintains the airtightness and appropriate fastening pressure of reactive gases and cooling water, and a bipolar plate that move reactive gases and cooling water.

In the fuel cell stack 10, hydrogen as a fuel and air (oxygen) as an oxidant may be supplied to the anode and cathode of the membrane electrode assembly through the flow path of the bipolar plate, respectively. For example, hydrogen may be supplied to the anode, which is a hydrogen electrode, and air may be supplied to a cathode, which is an air electrode.

The hydrogen supplied to the anode may be decomposed into protons and electrons by the catalysts of electrode layers formed on both sides of the electrolyte membrane, and only protons may be selectively transferred to the cathode through the electrolyte membrane, which is a cation exchange membrane, and at the same time, electrons may be transferred to the cathode through the gas diffusion layer and the bipolar plate which are conductors. In the cathode, the protons supplied through the electrolyte membrane and electrons transferred through the bipolar plate may meet oxygen in air supplied to the cathode by an air supply device to cause a reaction to generate water. The electrons may flow through an external conductor due to the movement of protons occurring in this case and current may be generated by the flow of the electrons.

A fuel cut-off valve FCV, a fuel supply valve FSV, a hydrogen ejector FEJ, and the like may be disposed in the hydrogen supply line 11. In addition, for example, the hydrogen supply line 11 may be connected to a hydrogen tank.

The fuel cut-off valve FCV may be disposed between the hydrogen tank and the fuel supply valve FSV in the hydrogen supply line 11, and may serve to block the supply of hydrogen discharged from the hydrogen tank to the fuel cell stack 10. The fuel cut-off valve FCV may be controlled such that the fuel cut-off valve FCV is opened when the ignition of the fuel cell system is turned on and closed when the ignition is turned off.

The fuel supply valve FSV may be disposed between the fuel cut-off valve FCV and the hydrogen ejector FEJ in the hydrogen supply line 11 and may serve to adjust a pressure of hydrogen supplied to the fuel cell stack 10. For example, the fuel supply valve FSV may be controlled such that the fuel supply valve FSV is opened to supply hydrogen when the pressure of the hydrogen supply line 11 is reduced, and closed when the pressure of the hydrogen supply line 11 is increased.

The hydrogen ejector FEJ may be disposed between the fuel supply valve FSV and the fuel cell stack 10 in the hydrogen supply line 11, and may serve to pressurize hydrogen passing through the fuel supply valve FSV to supply the hydrogen to the fuel cell stack 10.

The hydrogen supply line 11 may form a circulation route of hydrogen by connecting the outlet of the fuel cell stack 10 and the hydrogen ejector FEJ. Therefore, the hydrogen discharged by the hydrogen ejector FEJ may react with the air in the fuel cell stack 10 to generate electrical energy, and unreacted hydrogen may be discharged through the outlet of the fuel cell stack 10 and then reintroduced into the hydrogen ejector FEJ. In this case, the unreacted hydrogen may be reintroduced into the hydrogen ejector FEJ to allow the unreacted hydrogen to be supplied to the fuel cell stack 10 again to increase hydrogen reaction efficiency.

In the process of recycling hydrogen which is unreacted at the hydrogen electrode of the fuel cell stack 10, moisture present in the hydrogen supply line 11 may be condensed. In this case, the condensed water may be discharged through the first discharge line 31 connecting a point on the hydrogen supply line 11 where the hydrogen unreacted at the hydrogen electrode of the fuel cell stack 10 is moved to the hydrogen ejector FEJ and an air humidifier AHF.

A fuel water trap FWT and a fuel drain valve FDV may be disposed on the first discharge line 31.

The fuel water trap FWT may serve to store condensed water introduced into the first discharge line 31 from a point on the hydrogen supply line 11.

The fuel drain valve FDV may serve to discharge the condensed water stored in the fuel water trap FWT to the air humidifier AHF along the first discharge line 31. Here, the fuel drain valve FDV may be controlled such that the fuel drain valve FDV is closed before the condensed water stored in the fuel water trap FWT exceeds a certain level, and is opened when the condensed water stored in the fuel water trap FWT exceeds the certain level to discharge the condensed water along the first discharge line 31.

An air compressor ACP, the air humidifier AHF, an air cut-off valve ACV and the like may be disposed in the air supply line 21.

The air compressor ACP may be disposed between an air inlet for sucking ambient air in the air supply line 21 and the air humidifier AHF and may serve to suck in and compress the ambient air and supply compressed air.

The air humidifier AHF may be disposed between the air compressor ACP and the air cut-off valve ACV in the air supply line 21, and may serve to adjust the humidity of air sucked and compressed by the air compressor ACP and supply the air to the air electrode of the fuel cell stack 10. When the air compressed by the air compressor ACP is introduced into, the air humidifier AHF may control humidity by supplying moisture to the introduced air. For example, the air humidifier AHF may humidify air supplied from the air compressor ACP using the condensed water introduced through the first discharge line 31 or moisture contained in air discharged through the second discharge line 33 connecting the air electrode of the fuel cell stack 10 and the air humidifier AHF.

The air humidifier AHF may be connected to the first discharge line 31. Accordingly, the air humidifier AHF may supply moisture to the air supplied from the air compressor ACP by using the condensed water introduced through the first discharge line 31.

In addition, the air humidifier AHF may be connected to the air outlet of the fuel cell stack 10 through the second discharge line 33, and the air discharged from the air electrode of the fuel cell stack 10 may be introduced into the air humidifier AHF through the second discharge line 33. Because the air discharged from the air electrode of the fuel cell stack 10 contains moisture, the air humidifier AHF may accomplish humidification by moisture exchange between the air discharged from the air electrode of the fuel cell stack 10 and the air supplied from the air compressor ACP. In this way, the air supplied with moisture by the air humidifier AHF may flow into the cathode of the fuel cell stack 10 and reacts with hydrogen to generate water as a reactant.

On the other hand, the air humidifier AHF may be connected to an external outlet through the third discharge line 35 to discharge the air introduced through the second discharge line 33 to the outside through the third discharge line 35. In this case, an air exhaust valve AEV may be disposed in the third discharge line 35.

The air cut-off valve ACV may be disposed on the air supply line 21 connecting the fuel cell stack 10 and the air humidifier AHF to block hydrogen discharged from the air humidifier AHF from being supplied to the air electrode of the fuel cell stack 10 or control the pressure of air supplied to the air electrode of the fuel cell stack 10. For example, the air cut-off valve ACV may be controlled such that air cut-off valve ACV is opened when the ignition of the fuel cell system is turned on and closed when the ignition is turned off.

Also, the air cut-off valve ACV may be connected to the second discharge line 33 connecting the fuel cell stack 10 and the air humidifier AHF. The air cut-off valve ACV may block air discharged from the air electrode of the fuel cell stack 10 from being supplied to the air humidifier AHF through the second discharge line 33, or control the pressure of the air discharged to the air humidifier AHF from the air electrode of the fuel cell stack 10.

Although the air cut-off valve ACV is illustrated as being disposed in the air supply line 21 and the second discharge line 33 in an integrated manner, a first air cut-off valve (not shown) disposed on the air supply line 21 and a second air cut-off valve (not shown) disposed on the second discharge line 33 may be implemented in a separated manner.

Meanwhile, a purge line may be connected to a point on the hydrogen supply line 11 through which hydrogen supplied from the hydrogen ejector FEJ to the hydrogen electrode of the fuel cell stack 10 moves, and a fuel-line purge valve FPV 110 may be disposed on the purge line.

The fuel-line purge valve FPV 110 is a valve that is opened and closed to manage a hydrogen concentration in the fuel cell stack 10 and the hydrogen supply line 11 and may serve to maintain the hydrogen concentration in the fuel cell stack 10 and the hydrogen supply line 11 within a predetermined range.

The fuel cell stack 10 may generate electric energy by combining hydrogen and air, and the fuel-line purge valve FPV 110 may be closed while the fuel cell stack 10 operates in a normal state.

Here, the air supplied to the fuel cell stack 10 may include nitrogen or the like in addition to oxygen, and a crossover may occur due to a difference in nitrogen partial pressure between the hydrogen electrode and the air electrode, resulting in a decrease in cell voltage. Accordingly, the fuel-line purge valve FPV 110 may discharge residual hydrogen to increase the hydrogen concentration in the hydrogen electrode, thereby lowering the nitrogen concentration to maintain stack performance. The fuel-line purge valve FPV 110 may be opened to purge hydrogen when the cumulative current calculated by integrating the current generated in the fuel cell stack 10 for a predetermined period of time is greater than a target value, thereby being controlled such that the hydrogen concentration in the hydrogen electrode is maintained above a predetermined value.

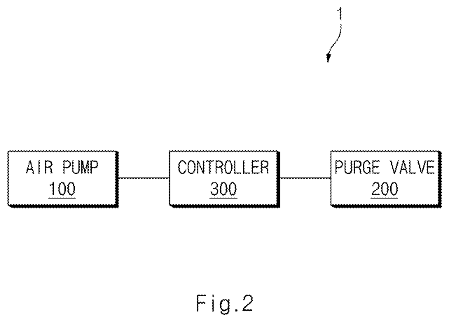

FIG. 2 is a block diagram of a fuel cell system according to an embodiment disclosed herein.

Referring to FIG. 2, a fuel cell system 1 may include an air pump 100, a purge valve 200, and a controller 300.

According to the embodiment, the air pump 100 may inject air into the fuel cell stack through rotation of a pump. In this case, the air pump 100 may inject air (oxygen) serving as an oxidant into the air electrode (or cathode) of the fuel cell stack. The air injected by the air pump 100 may react with hydrogen supplied to a hydrogen electrode (or anode) to generate electricity. The air pump 100 may be substantially the same as the air compressor ACP shown in FIG. 1.

According to an embodiment, the purge valve 200 may perform hydrogen purging based on an opening degree. The purge valve 200 may perform hydrogen purging by opening a valve based on control of the controller 300 to be described later. The opened/closed state of the purge valve 200 may have two states of an opened state or a closed state, and the purge valve 200 may perform hydrogen purging based on the opening degree of the valve. For example, the purge valve 200 may be changed to an opened state or a closed state according to the opening degree of the valve, and may perform hydrogen purging in the opened state. In some cases, the purge valve 200 may have an opening rate between 0% and 100% based on a completely closed state (closed) and a completely opened state. The purge valve 200 may be substantially the same as the fuel-line purge valve FPV 110 shown in FIG. 1.

According to an embodiment, the controller 300 may be a hardware device such as a processor, a micro processor unit (MPU), a micro controller unit (MCU), a central processing unit (CPU), or an electronic controller unit (ECU), or a program implemented by a processor. The controller 300 may be connected to each component of the fuel cell system 1 to perform overall functions related to management and operation of the fuel cell stack. For example, the controller 300 may be a fuel cell control unit (FCU) that controls overall functions of the fuel cell system.

According to the embodiment, the controller 300 may calculate a cumulative current of a fuel cell. The controller 300 may calculate the cumulative current by integrating a current generated by the fuel cell system 1.

According to an embodiment, the controller 300 may perform a first operation of controlling the number of rotations of the air pump 100.

According to an embodiment, the controller 300 may decrease the number of rotations of the air pump 100 when the cumulative current is greater than or equal to a first value (e.g., 2700 mA). In this way, when the number of rotations of the air pump 100 is decreased, the air partial pressure at the air electrode may be lowered, and accordingly, the nitrogen crossover phenomenon caused by the pressure difference may be reduced.

According to an embodiment, the controller 300 may decrease the number of rotations of the air pump 100 by dividing the number of rotations of the air pump 100 by a preset value (e.g., 2) when the cumulative current is equal to or greater than the first value. The preset value may be determined by the partial pressures of gas at the hydrogen electrode and the air electrode, the hydrogen concentration at the hydrogen electrode, and the like.

According to an embodiment, the controller 300 may perform a second operation of controlling the opening degree of the purge valve 200 based on the cumulative current. In this case, controlling the opening degree of the purge valve 200 may be understood as controlling the state (e.g., opened state or closed state) of the purge valve 200.

For example, the controller 300 may open the purge valve 200 to perform hydrogen purging when the cumulative current calculated by accumulating a current generated in the fuel cell stack is equal to or greater than a reference value (e.g., 3000 mA). In this case, opening the purge valve 200 may mean controlling the state of the purge valve 200 to an opened state. Here, the reference value may be a cumulative current value serving as a preset reference for hydrogen purging, and may be set based on specifications of a fuel cell stack, a driving state of a vehicle equipped with the fuel cell system 1, and the like. For example, the reference value may include a cumulative current value at a point in time when the nitrogen partial pressure in the hydrogen electrode of the fuel cell stack is expected to be higher than a reference pressure.

According to an embodiment, the reference value (e.g., 3000 mA) may be set larger than the first value (e.g., 2700 mA). Because the controller 300 controls the purge valve 200 to perform hydrogen purging when the cumulative current reaches the reference value, the controller 300 may control the number of rotations of the air pump 100 in advance when the cumulative current reaches the first value before reaching the reference value.

Nitrogen crossover in the fuel cell stack may be most likely to occur at the moment when hydrogen is purged. Because the partial pressure in the hydrogen electrode is momentarily lowered at the moment when hydrogen is purged, more nitrogen crossover from the air electrode to the hydrogen electrode may occur. That is, when the partial pressure of the air electrode is lowered by predicting a time point at which hydrogen is purged, the nitrogen crossover phenomenon may be reduced during hydrogen purging, compared to the prior art. Therefore, the fuel cell system 1 may predict the time point at which hydrogen is purged, and reduce the number of rotations of the air pump 100 from a predetermined time (e.g., when the cumulative current reaches the first value) before the time when the hydrogen purging is predicted to be performed (e.g., when the cumulative current reaches the reference value) to reduce the partial pressure in the air electrode, thereby reducing nitrogen crossover that occurs at the moment when the purge valve 200 is opened and hydrogen is purged.

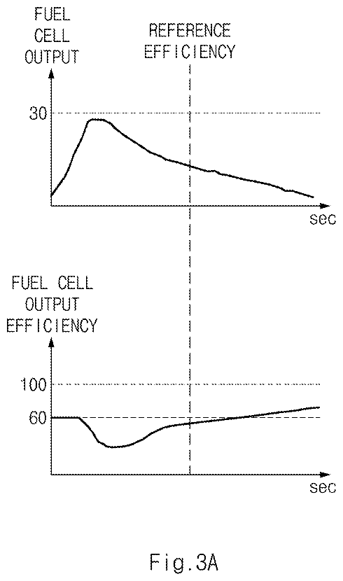

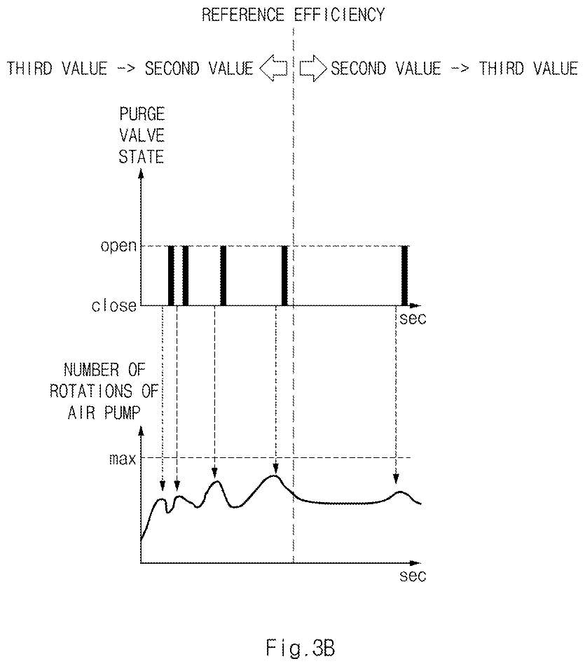

FIG. 3A is a diagram illustrating a process of determining reference efficiency of a fuel cell system according to an embodiment disclosed herein.

FIG. 3B is a diagram illustrating a process of controlling purging timing of a purge valve based on the output efficiency of a fuel cell system according to an embodiment disclosed herein.

Referring to FIGS. 3A and 3B, the fuel cell system 1 may determine reference efficiency based on the output efficiency of a fuel cell and control the hydrogen purging timing of the purge valve 200 based on the reference efficiency.

According to an embodiment, the controller 300 may control a reference value based on the output efficiency of the fuel cell. It can be understood that the reason why the fuel cell system 1 performs hydrogen purging is to prevent a decrease in hydrogen concentration due to nitrogen crossover and thus a reduction in output efficiency of the fuel cell. In this case, the reference value may mean a cumulative current value for determining the hydrogen purging timing according to the cumulative current of the fuel cell, and it may be determined that the hydrogen purging timing may be delayed when the output efficiency of the fuel cell is sufficient even though the cumulative current reaches the reference value. Accordingly, when the output efficiency of the fuel cell is sufficient even though the cumulative current is close to the reference value, the controller 300 may adjust the reference value of the cumulative current larger to delay the purging timing. Conversely, when the output efficiency of the fuel cell is low, it may be possible to adjust the reference value smaller to advance the purging timing.

According to an embodiment, the controller 300 may determine the reference efficiency based on the output efficiency of the fuel cell. The reference efficiency may be determined based on the output and output efficiency of the fuel cell, and may be set to, for example, an output efficiency value at a point where the output efficiency starts to increase after decreasing.

According to an embodiment, the controller 300 may adjust the reference value from the second value (e.g., 3000 mA) to the third value (e.g., 4000 mA) when the output efficiency of the fuel cell is equal to or greater than the reference efficiency. In this case, the third value may be set greater than the second value. When the output efficiency of the fuel cell is greater than the reference efficiency, the fuel cell system 1 may consume hydrogen more efficiently by delaying the hydrogen purging timing and lowering the frequency of hydrogen purging.

According to an embodiment, the controller 300 may adjust the reference value from the third value (e.g., 4000 mA) to the second value (e.g., 3000 mA) when the output efficiency of the fuel cell is less than the reference efficiency after being greater than or equal to the reference efficiency. That is, when the nitrogen concentration is increased and the output efficiency of the fuel cell is lowered again in a state in which the controller 300 has lowered the frequency of hydrogen purging by delaying the hydrogen purging timing because the output efficiency of the fuel cell is higher than the reference efficiency, the controller may increase the frequency of hydrogen purging by lowering the cumulative current reference value, which is the criterion for hydrogen purging, from the third value to the second value, thereby adjusting the nitrogen concentration to increase the output efficiency of the fuel cell.

As described above, the fuel cell system 1 may adjust the purging timing and the frequency of hydrogen purging by adjusting the cumulative current reference value, which is the criterion for hydrogen purging, according to the state of the fuel cell, thus generating power and consuming hydrogen more efficiently.

According to an embodiment, the controller 300 may adjust the first value based on the reference value. For example, the controller 300 may adjust the reference value based on the output efficiency of the fuel cell, and adjust the first value based on the reference value. For example, the controller 300 may set the first value to a value (e.g., 2700 mA) smaller than the second value by a predetermined level when the reference value is set to the second value (e.g., 3000 mA) and set the reference value to a value (e.g., 3700 mA) smaller than the third value by a predetermined level when the reference value is set to the third value (e.g., 4000 mA). That is, because the fuel cell system 1 is intended to predict the hydrogen purging timing and control the air pump 100 a predetermined time before the time when the hydrogen purging is predicted to be performed to prevent nitrogen crossover, the controller 300 may adjust the first value to have a value smaller than the reference value by a predetermined level based on the reference value when the reference value related to the hydrogen purging timing is adjusted.

In FIG. 3B, it can be seen that hydrogen purging is performed when the purge valve is open, and the frequency of the hydrogen purging varies according to the reference value. In addition, it can be seen that the number of rotations of the air pump 100 is reduced before a predetermined time before the hydrogen purging timing.

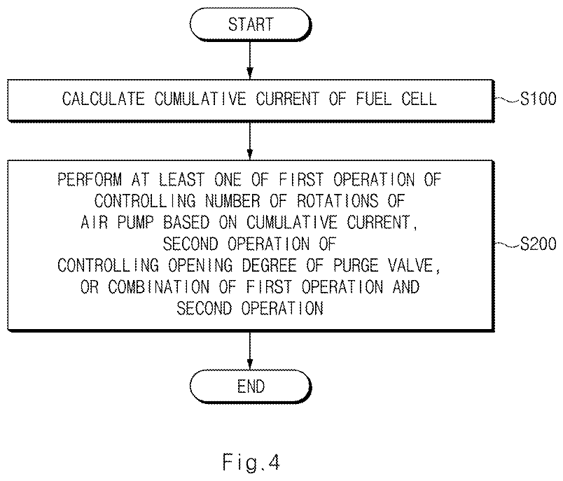

FIG. 4 is a flowchart for describing a purging control method for a fuel cell according to an embodiment disclosed herein.

Referring to FIG. 4, the purging control method for the fuel cell may include calculating a cumulative current of a fuel cell (S100) and performing a first operation of controlling the number of rotations of the air pump 100 based on the cumulative current, performing a second operation of controlling an opening degree of the purge valve 200, or performing at least one of a combination of the first operation and the second operation (S200).

In S100, the controller 300 may calculate the cumulative current of the fuel cell.

In S200, the controller 300 may perform the first operation of controlling the number of rotations of the air pump 100. Also, the controller 300 may perform the second operation of controlling the opening degree of the purge valve based on the cumulative current.

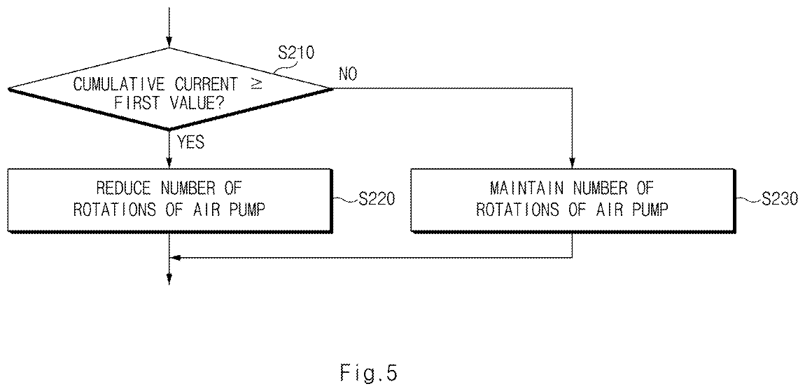

FIG. 5 is a diagram showing a method of adjusting the number of rotations of an air pump according to an embodiment disclosed herein.

Referring to FIG. 5, the controller 300 may adjust the number of rotations of the air pump 100 based on a cumulative current.

In S210, the controller 300 may compare the cumulative current with a first value. When the cumulative current is greater than or equal to the first value (S210—Yes), the fuel cell system 1 may proceed to S220. When the cumulative current is less than the first value (S210—No), the fuel cell system 1 may proceed to S230.

In S220, the controller 300 may decrease the number of rotations of the air pump 100.

In S230, the controller 300 may maintain the number of rotations of the air pump 100.

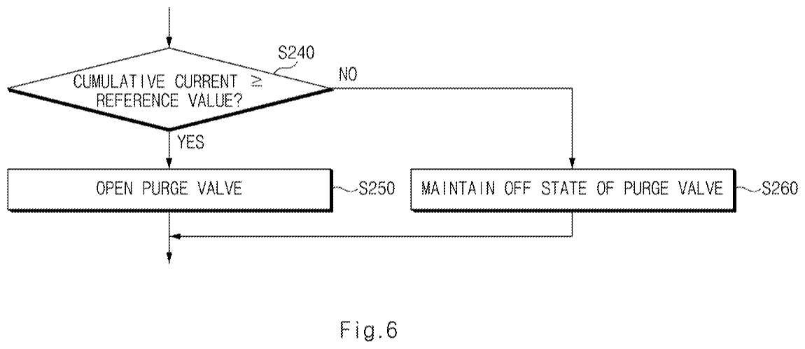

FIG. 6 is a diagram showing a method of controlling a purge valve according to an embodiment disclosed herein.

Referring to FIG. 6, the controller 300 may control the purge valve 200 based on a cumulative current.

In S240, the controller 300 may compare the cumulative current with a reference value. The fuel cell system 1 may proceed to S250 when the cumulative current is greater than or equal to the reference value (S240—Yes). When the cumulative current is less than the reference value (S240—No), the fuel cell system 1 may proceed to S260.

In S250, the controller 300 may perform control to open the purge valve 200.

In S260, the controller 300 may perform control such that the purge valve 200 is maintained in an opened state.

In the above, even though all the components constituting the embodiments disclosed herein have been described as being combined as one component or operated as one component, the embodiments disclosed herein are not necessarily limited to these embodiments. That is, all of the components may be selectively combined with one or more to operate within the scope of the objectives of the embodiments disclosed herein.

Also, the terms such as “include,” “comprise,” or “have” specify the presence of a stated element but do not preclude the addition of one or more other elements unless otherwise specified. All terms, including technical or scientific terms, have the same meaning as commonly understood by a person of ordinary skill in the art to which the embodiments disclosed in this document belong, unless defined otherwise. Generally-used terms as those defined in a dictionary are to be interpreted as having meanings equal to the contextual meanings in the relevant field of art, and are not to be interpreted as having ideal or excessively formal meanings unless clearly defined in the disclosure.

The above description is merely illustrative of the technical idea of the present disclosure, and various modifications and variations may be made without departing from the essential characteristics of the embodiments of the present disclosure by those skilled in the art to which the embodiments of the present disclosure pertains. Therefore, the embodiments of the present disclosure are provided to explain the spirit and scope of the embodiments of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

The fuel cell system according to the embodiments disclosed herein may reduce nitrogen crossover by adjusting the air partial pressure by controlling the number of rotations of the air pump.

The fuel cell system according to the embodiments herein may reduce nitrogen crossover at the time of hydrogen purging by adjusting the number of rotations of the air pump in advance before the time at which hydrogen purging is expected to be performed.

The fuel cell system according to the embodiments disclosed herein may adjust the purging timing by adjusting the cumulative current reference value, which is the criterion for hydrogen purge, according to the state of the fuel cell, thus generating power and consuming hydrogen more efficiently.

In addition to this, various effects identified directly or indirectly through this document may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A fuel cell system comprising:
an air pump configured to inject air into a fuel cell stack;
a purge valve configured to perform hydrogen purging based on an opening degree of the purge valve; and
a controller configured to calculate a cumulative current of the fuel cell stack and perform at least one of a first operation of controlling a number of rotations of the air pump based on the cumulative current, a second operation of controlling the opening degree of the purge valve, or a combination of the first operation and the second operation.

2. The fuel cell system of claim 1, wherein the controller is configured to reduce the number of rotations of the air pump in response to a result that the cumulative current is greater than or equal to a first value.

3. The fuel cell system of claim 2, wherein the controller is configured to control the purge valve by opening the purge valve to cause the purge valve to perform the hydrogen purging in response to a result that the cumulative current is greater than or equal to a reference value.

4. The fuel cell system of claim 3, wherein the reference value is set greater than the first value.

5. The fuel cell system of claim 3, wherein the controller is configured to adjust the reference value based on an output efficiency of the fuel cell stack.

6. The fuel cell system of claim 5, wherein the controller is configured to determine a reference efficiency based on the output efficiency.

7. The fuel cell system of claim 6, wherein the controller is configured to adjust the reference value from a second value to a third value in response to a result that the output efficiency is greater than or equal to the reference efficiency, and
wherein the third value is set greater than the second value.

8. The fuel cell system of claim 7, wherein the controller is configured to adjust the reference value from the third value to the second value in response to a result that the output efficiency is less than the reference efficiency after being equal to or greater than the reference efficiency.

9. The fuel cell system of claim 5, wherein the controller is configured to adjust the first value based on the reference value.

10. A purging control method for a fuel cell stack, comprising:
calculating a cumulative current of the fuel cell stack; and
performing at least one of a first operation of controlling a number of rotations of an air pump based on the cumulative current, a second operation of controlling an opening degree of a purge valve, or a combination of the first operation and the second operation.

11. The purging control method of claim 10, wherein the performing of the at least one of the first operation of controlling the number of rotations of the air pump based on the cumulative current, the second operation of controlling the opening degree of the purge valve, or the combination of the first operation and the second operation includes:
comparing the cumulative current with a first value; and
reducing the number of rotations of the air pump when the cumulative current is equal to or greater than the first value.

12. The purging control method of claim 10, wherein the performing of the at least one of the first operation of controlling the number of rotations of the air pump based on the cumulative current, the second operation of controlling the opening degree of the purge valve, or the combination of the first operation and the second operation includes:
comparing the cumulative current with a second value; and
opening the purge valve when the cumulative current is greater than or equal to the second value.
